(19) United States
(12) Patent Application Publication
(10) Pub. No.: US 2018/0355637 A1
(43) Pub. Date: Dec. 13, 2018

(54) INTERCHANGEABLE CYLINDER LOCK CORE FOR A CYLINDER LOCK UNIT

(71) Applicant: WINLOC AG, Zug (CH)

(72) Inventor: Bo WIDÉN, Torshalla (SE)

(73) Assignee: WINLOC AG, Zug (CH)

(21) Appl. No.: 15/617,779

(22) Filed: Jun. 8, 2017

(51) Int. Cl. E05B 63/00; E05B 27/00; E05B 35/08; E05B 19/00

(52) U.S. Cl. CPC E05B 63/0056; E05B 27/0039; E05B 19/0064; E05B 27/0082; E05B 35/08; E05B 27/0003

(57) ABSTRACT

An interchangeable cylinder lock core with a mechanism for transferring a torque to a lock unit when a key plug is rotated. The interchangeable cylinder lock core includes a shell having an upper part, provided with a central row of locking pins in associated cavities, and a lower part with a cylindrical bore accommodating the rotatable key plug. At least a part of the cylindrical bore extends through a rotatable retainer sleeve. A back region of the key plug has a minimum length with the adjoining front region of the key plug being located in front of the mechanism for transferring torque. The adjoining front region accommodates, in addition to the central row of locking pins, at least one side locking mechanism which is located in its entirety within the front region of the key plug and interacts with at least one recess in a fixed front end sleeve portion.

### FIELD OF THE INVENTION

The present invention relates to an interchangeable cylinder lock core with a rotatable cylindrical key plug for use together with a lock unit having a housing dimensioned to receive the interchangeable cylinder lock core, of the kind specified in the preamble of the appended claim 1. Thus, in the housing of the lock unit, there is a torque transferring mechanism, in the form of a pair of prongs, adapted to transfer a torque to the lock unit when the key plug of the interchangeable cylinder lock core is rotated. More particularly, the interchangeable cylinder core comprises:

a shell having an outer contour dimensioned to fit into said housing,

the shell comprising an upper part, provided with a central row of locking pins in associated cavities, and a lower part with a cylindrical bore accommodating the rotatable key plug, at least a part of the cylindrical bore extending through a rotatable retainer sleeve,

the rotatable key plug also being provided with a central row of associated cavities cooperating with the central row of locking pins,

the rotatable retainer sleeve being provided with holes corresponding to the cavities for the locking pins and also being provided with an engaging member, adapted to releasably retain the interchangeable cylinder lock core in the housing, and to enable removal and replacement of the interchangeable cylinder lock core in relation to the housing of the lock unit,

the key plug being rotatable in the cylindrical bore and having a back region extending from a back end, and a front region, which adjoins the back region and extends up to a front end of the key plug,

a keyway extending from the front end axially along the key plug and being configured to accommodate an associated key,

said central row of locking pins being arranged to engage with and lock the key plug against rotation in the lower part of the shell unless a correctly cut key is inserted into said keyway,

there being two longitudinal prong holes extending along the whole length of the back region of the key plug from the back end thereof so as to provide, in use together with the lock unit, an effective guiding of the prongs and a secure engagement of the two prongs in the prong holes, when the key plug is being rotated while transferring a torque onto the two prongs.

The invention also relates to a lock and key system including an interchangeable cylinder lock core of the above-defined kind, wherein the system comprises a first key for removal and replacing the interchangeable cylinder lock core in relation to the lock unit, and at least one second key for opening the cylinder lock core while retaining the cylinder lock core in the lock unit.

Moreover, the invention relates to a key for opening an interchangeable cylinder lock core of the kind specified above.

### BACKGROUND OF THE INVENTION

Such lock and key systems, lock units and associated interchangeable cylinder lock cores are frequently used, especially in the US, in locking systems with a large number of lock units serving as door locks. From time to time, many of these cylinder lock cores need to be replaced quickly whenever an associated key is lost, or a new tenant, owner or user wishes to upgrade the door lock with a new cylinder lock core.

Since the 1930's the Best Lock Company has dominated the US market for this kind of locking systems. Accordingly, there exist today a huge number of such door lock units. A number of manufacturers are providing their own interchangeable cylinder lock cores to replace the existing ones.

However, in general, there are no really high security interchangeable lock cylinder cores on the market.

One reason for this is that the key plug has a relatively small diameter and that most of the space is occupied by cavities for accommodating the locking pins, a keyway as well as the two prong holes in the back region of the key plug. There is no room for a conventional side bar or other kinds of side tumbler mechanisms which normally require a longitudinal extension along the full length of the key plug.

Another reason is that the two prong holes have to be dimensioned so that even a relatively high torque can be transferred to the lock unit by way of a cam or some other locking device coupled to the lock unit, e.g. for closing a door effectively. Therefore, the cam or other locking device has to be securely fastened to each of the prongs, and the prongs have to fit well into the prong holes. They must not lose their engagement or break.

Also, in order to enable an easy mounting of the cylinder lock core into the housing of the existing lock unit, there must be a certain play between the prong holes and the prongs, so as to enable an easy and effective guiding of the prongs into the prong holes. Once, mounted, the engagement must be secure, with no risk for disengagement or breakage.

Accordingly, a good guidance and an effective engagement between the prongs and the prong holes will require that the two prong holes in the back region of the key plug are relatively long, preferably having mutually the same length, so that they will symmetrically carry the same load when a torque is applied.

A recently developed system, including an interchangeable cylinder lock core of the kind defined in the first paragraph above is disclosed in U.S. Pat. No. 8,186,194 (Field et al). In this prior art system, the lock comprises a conventional cylinder lock with a shell and a key plug having two long prong holes in a back region and an auxiliary side locking system which is separate from the normal central row of locking pins. The auxiliary side locking system comprises an auxiliary locking pin being disposed in an associated hole in a side region of the key plug and being movable between a first position, in which a portion thereof projects outside the key plug, and a second position in which the auxiliary locking pin is retracted into said hole. A slider arranged in the key plug, underneath the auxiliary locking pin, is movable axially along the key plug between a first position, where it holds the auxiliary pin in said first position, and a second position, where it permits the auxiliary pin to fall down to its second, retracted position. In this way, the key plug is released so that it may be rotated within the shell. In an alternative embodiment, the auxiliary pin engages directly with a retainer sleeve which surrounds the key plug.

The auxiliary side locking system will ensure that the key plug is effectively locked in its rotary position and cannot rotate as long as the slider is held in its first position. Even if all the regular locking pins are manipulated or “bumped” into their correct releasing positions in an attempt to pick the lock, the remaining auxiliary side locking pin will prevent rotation of the key plug. So, this prior art system will substantially increase the safety against lock picking.

In another prior art exchangeable lock construction of similar design, disclosed in the U.S. Pat. No. 6,981,396 (Kim), there is a key plug with a side locking mechanism including a sidebar which interacts with a number of side locking tumblers. The side bar also interacts with a retainer sleeve (a “tubular operation body”) which extends along the full length of the key plug. Accordingly, on the side provided with the side bar, the key plug will be solid virtually all the way to its rear end, and the associated prong in the associated lock unit will have to be sheared in order to accommodate the key plug and its security full length sidebar. With this construction, the torque to be transferred to the lock unit, by rotating the key plug by means of an inserted key, will be effected by means of one prong only, situated on the opposite side of the key plug.

### OBJECTS OF THE INVENTION

There is always a need for further improvement, and the main object of the present invention is to further increase the security and provide an interchangeable cylinder lock core with a high security side locking mechanism which is very difficult to manipulate so as to open the lock without using a properly cut key and which will also permit the key plug to have two long prong holes, so that the prongs may be securely engaged with both of the prong holes in the key plug, when the interchangeable cylinder lock core is inserted and retained within the lock unit.

### SUMMARY OF THE INVENTION

This object is achieved by providing an interchangeable cylinder lock core with the following features:

the back region of the key plug, accommodating the two longitudinal prong holes, has a length of at least half of the length of the key plug, the adjoining front region, located in front of the longitudinal prong holes, thus having a length being no longer than half of the length of the key plug,

the adjoining front region accommodates, in addition to said central row of locking pins, at least one side locking mechanism, which is located in its entirety within said front region of the key plug and is adapted to interact with at least one recess in a fixed front end sleeve portion,

the fixed front end sleeve portion, forming a portion of said lower part of said shell, is located radially outside said front region of the key plug and is provided with at least one recess for receiving and engaging with at least one radially projecting part of said at least one side locking mechanism,

the at least one side locking mechanism is operative independently of the central row of locking pins and is disposed on at least one lateral side of the key plug, and

each side locking mechanism comprises a longitudinal row of at least two coded side locking tumblers which are movable independently of each other, there being at least three different code positions for each coded side locking tumbler and a plurality of different code combinations for the side locking tumblers in the longitudinal row in said front region of the key plug.

In contrast to some of the prior art structures discussed above, there is a direct contact between the side locking tumblers and an associated key, without the intermediary of any other moving part, such as the axially movable slider in the above-mentioned prior art system. In this way, the structure will be relatively simple and reliable. Because of the different code positions for each locking tumbler in the row, the number of possible combinations will be very large, so the security will be high.

The front region of key plug is preferably substantially solid, except for the keyway, the cavities for the locking pins and any recesses and holes for accommodating the side locking mechanism or mechanisms.

Thanks to the above-defined structure of the interchangeable cylinder lock core, with a fixed sleeve portion, forming a part of the shell accommodating the rotatable key plug and being located adjacent to the front end thereof, there will be a secure and distinct interaction between the key plug and the surrounding shell, by way of the side locking mechanism which is located in its entirety within the front region of the key plug.

Preferably, there is one relatively short (in the axial direction) side locking mechanism on each side of the keyway in the front region of the key plug. Then, it is possible to accommodate at least four (two on each side) independently movable locking tumblers being separate and independent from the conventional locking pins. However, it is also possible to arrange only one side locking mechanism arranged on one lateral side of the keyway.

The length of the front region of the key plug, where the at least one side locking mechanism is located in its entirety, is preferably rather short, e.g. 50%, about 40% or about 30% of the total length of the key plug. Nevertheless, thanks to the compact structure of the side locking mechanism, it can still provide a large number of code combinations and a high security for the interchangeable lock core.

It has turned out that each longitudinal row of side locking tumblers, on one or both lateral sides, may comprise at least two and preferably at least three (or even more) side locking tumblers.

The rotatable retainer sleeve may be arranged axially between a fixed front end sleeve portion and a rear end sleeve portion, where the fixed sleeve portions define the cylindrical bore together with the rotatable sleeve.

As an alternative, the rotatable retainer sleeve may extend from the back end of the key plug up to a fixed front end sleeve portion, or it may extend all the way up to the front end of the key plug. In the latter case, there must be through-going recesses or a longitudinal slot in this part of the retainer sleeve, so that the projecting part may reach the surrounding fixed front end sleeve portion and its recesses or slot.

As defined in the depending claims, the rotatable sleeve portion may have a thinner cylindrical wall than a fixed front end sleeve portion. It is also possible that a fixed front end sleeve portion as well as the rotatable retainer sleeve are provided with recesses at their inside cylindrical surfaces for accommodating a radially projecting part of the side locking mechanism.

Also, according to the present invention, there is provided a lock and key system including an interchangeable cylinder lock core as defined above, wherein the lock and key system comprises a first key for removal and replacement of the interchangeable cylinder lock core in relation to the lock unit, and at least one second key for opening the cylinder lock core while retaining the cylinder lock core in the lock unit, the second key comprising a grip portion and a key blade, wherein:

said key blade has an edge code pattern comprising a longitudinal continuous row of code portions defined by V-shaped bittings configured to interact with said central row of locking pins in said shell of the cylinder lock core, and

said key blade also has a wave-like side code pattern configured to interact with said at least one side locking mechanism being located in the front region of the key plug on at least one lateral side of said key plug, and

said wave-like side code pattern is confined substantially to the longitudinal half of the key blade located closest to said grip portion and comprises at least two coded portions configured to interact with said at least two side locking tumblers of the side locking mechanism, so as to position, upon being inserted into the key plug, the side locking tumblers in predetermined code locations that will open the lock by permitting rotation of the key plug within the lower part the shell, either directly by releasing the engagement of the side locking tumblers in relation to the fixed sleeve portion of the shell of the cylinder lock core, or via a sidebar interacting with the fixed sleeve portion of the shell of the cylinder lock core.

Further advantageous features are stated in the appended claims, and will also appear from the detailed description of some preferred embodiments, reference being made to the attached drawings.

### BRIEF DESCRIPTION OF THE DRAWINGS

FIG. 1 shows, in a perspective view, a lock unit and an inserted interchangeable cylinder lock core according to the present invention, including a key which is inserted into a key plug forming part of the interchangeable cylinder lock core;

FIGS. 2a and 2b show, in a perspective, exploded view, the interchangeable core with the key and the lock unit (with a part thereof cut away), respectively;

FIG. 3a shows a side view of the interchangeable cylinder lock core of FIG. 2a;

FIG. 3b shows a side view of the lock unit of FIG. 2b, being partially cut away to show the inside thereof;

FIG. 4a shows an exploded view of the various parts of a lock and key system according to the invention, including an interchangeable cylinder lock core, with a shell, a number of locking pins, a rotatable key plug, a retainer sleeve, and a side locking mechanism, and a key for operating the cylinder lock core;

FIG. 4b shows a perspective view of the key of FIGS. 2a and 3a, in a perspective view from the other side;

FIG. 4c shows a modified version of the interchangeable core of FIG. 4a, including a longer retainer sleeve and a front end sleeve portion;

FIG. 4d shows a further modified version of the interchangeable core of FIG. 4a, with a front end sleeve portion being integrated with a rear end sleeve portion;

FIG. 4e shows another modified version of the interchangeable core of FIG. 4a, with a full length retainer sleeve and a surrounding fixed sleeve;

FIGS. 4f, 4g, 4h and 4i show longitudinal sections through the interchangeable cores of FIGS. 4a, 4c, 4d and 4e, respectively;

FIG. 4k shows a cross-section through the interchangeable core of FIG. 4a, at the location of a side locking tumbler;

FIGS. 4l, 4m and 4n show cross-sections through the interchangeable core and a side locking tumbler (at the other side of the keyway) being coded in three different ways;

FIGS. 4o, 4p and 4q show the same cross-sections as in FIGS. 4l, 4m and 4n after withdrawal of the key from the keyway;

FIGS. 5a, 5b, 5c and 5d show the key plug of FIG. 4a, in views from below, from the front end, from above and in a longitudinal section, respectively;

FIG. 5e shows the prongs of the lock unit;

FIG. 6 shows a key plug of a similar embodiment as in FIG. 5d, but with four side locking tumbler holes in a row;

FIGS. 7a, 7b, 7c and 7d show a key plug of a second embodiment which is similar to the one of FIGS. 5a to 5d, but with a shorter side locking mechanism on each side of the key plug, with two locking tumblers in each side locking mechanism;

FIGS. 8a, 8b, 8c and 8d show a key plug of a modified embodiment which is similar to the one of FIGS. 5a to 5d, but with only six locking pins (instead of seven locking pins in the previous embodiments) and two side locking tumblers on each side of the key plug;

FIGS. 9a, 9b, 9c, 9d, 9e, 9f, 9g and 9h show, in various views, a third embodiment having two longer prong holes and a side locking mechanism provided with a side bar which cooperates with two side locking tumblers on one lateral side of the keyway;

FIG. 10 shows a modified embodiment of the side locking mechanism having a side bar interacting with side locking tumblers which are movable up and down and also rotatable around their own axes;

FIG. 11 shows another modified embodiment where the side locking tumblers are each provided with a longitudinally displaced finger;

FIGS. 12a, 12b, 12c and 12d show, in views corresponding to FIGS. 5a, 5b, 5c and 5d, respectively, an embodiment having three side locking tumblers interacting with a sidebar, on one lateral side of the keyway;

FIGS. 13a, 13b, 13c and 13d show, in views also corresponding to FIGS. 5a to 5d, a fourth embodiment with two side bars, one on each lateral side of the keyway of the key plug; and

FIGS. 14a, 14b, and 14c show, in views corresponding to FIGS. 5d, 4d and 4a, respectively, some further embodiments with a longer side bar on each lateral side of the keyway, each cooperating with four side locking tumblers in a row.

### DETAILED DESCRIPTION OF PREFERRED EMBODIMENTS

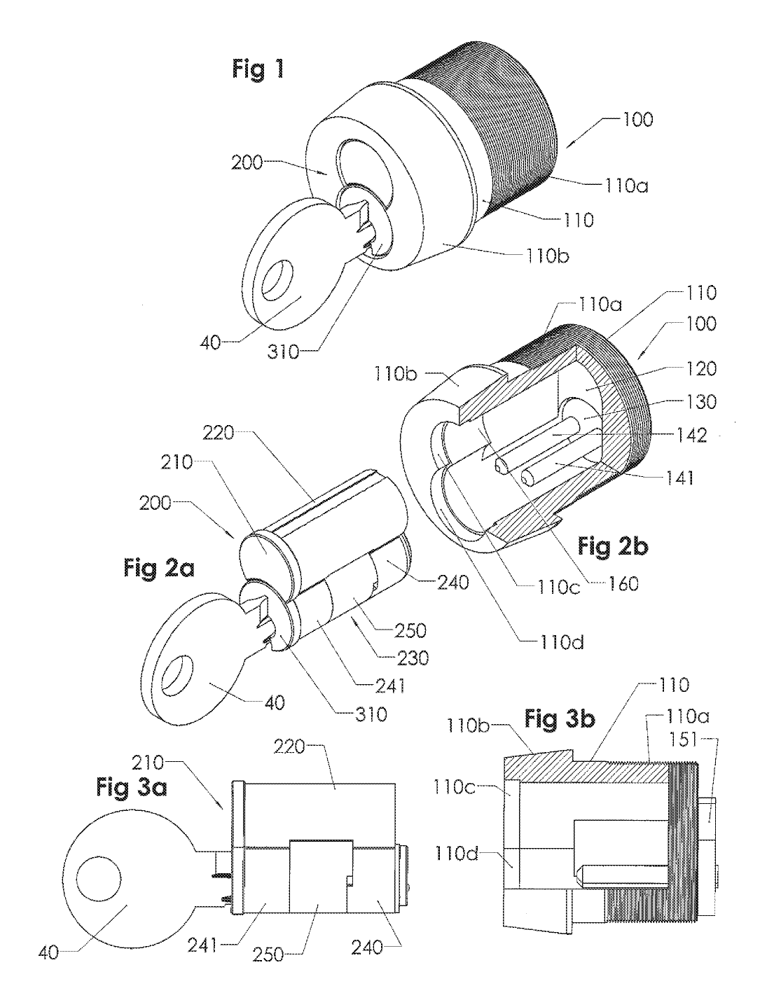

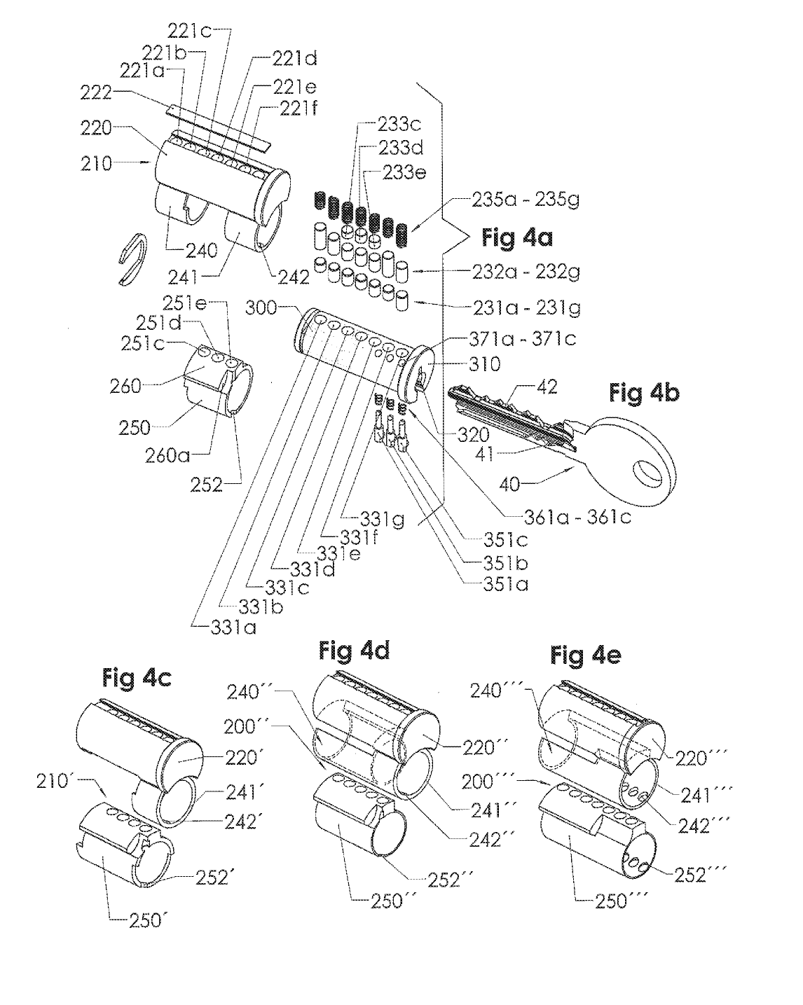

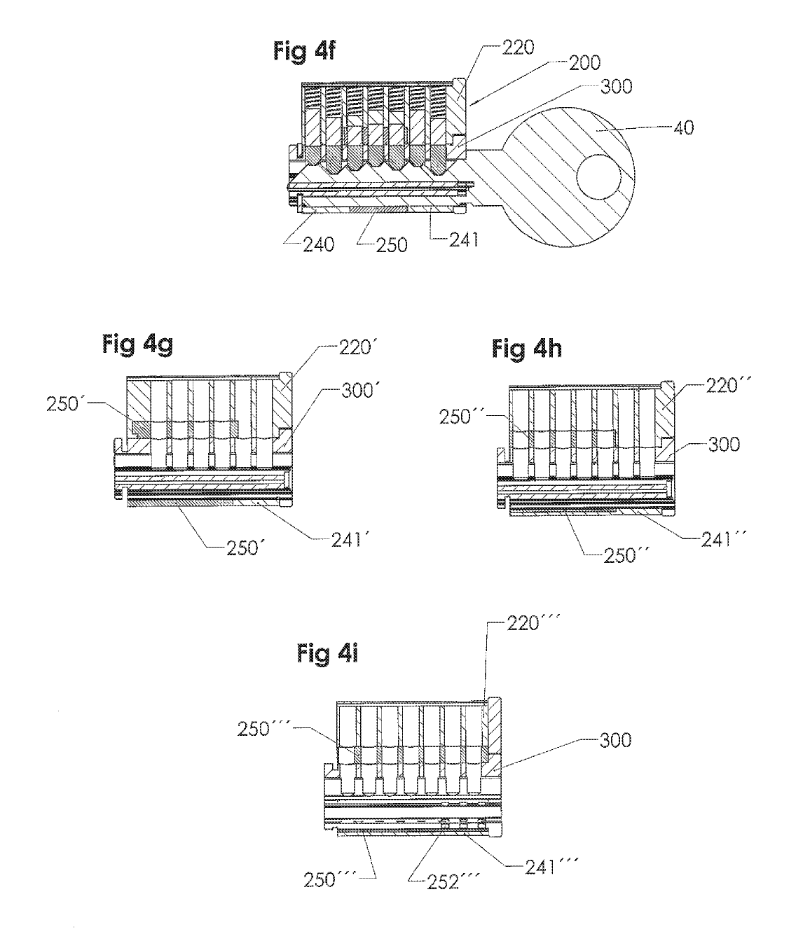

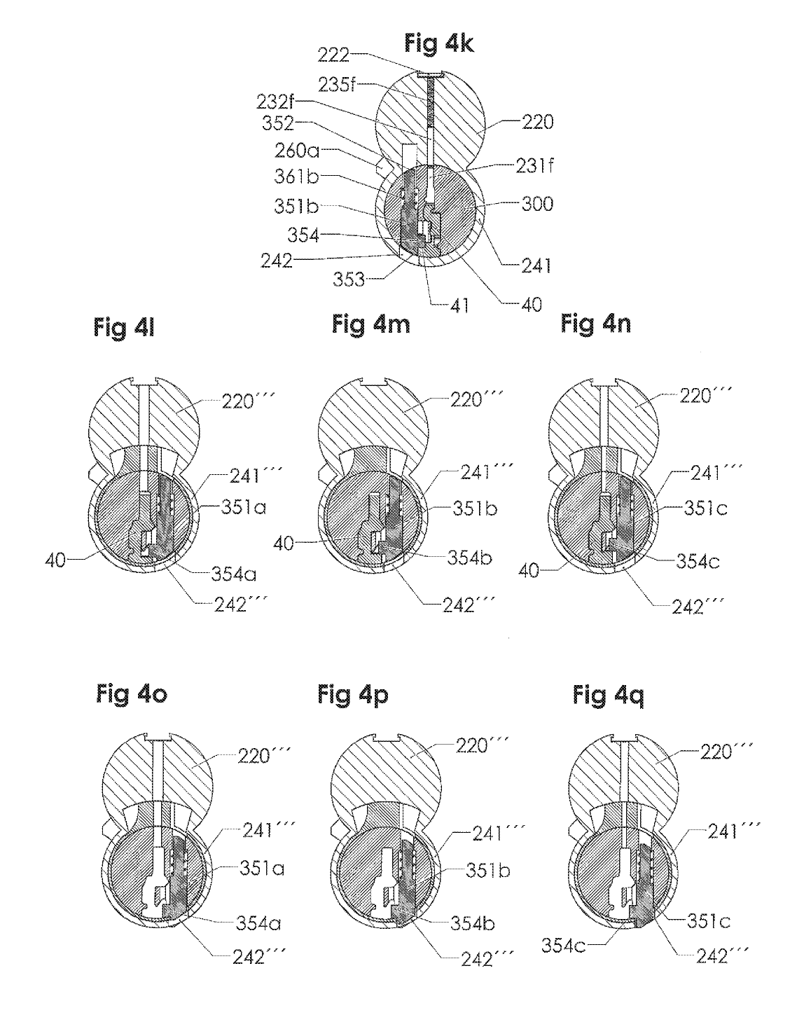

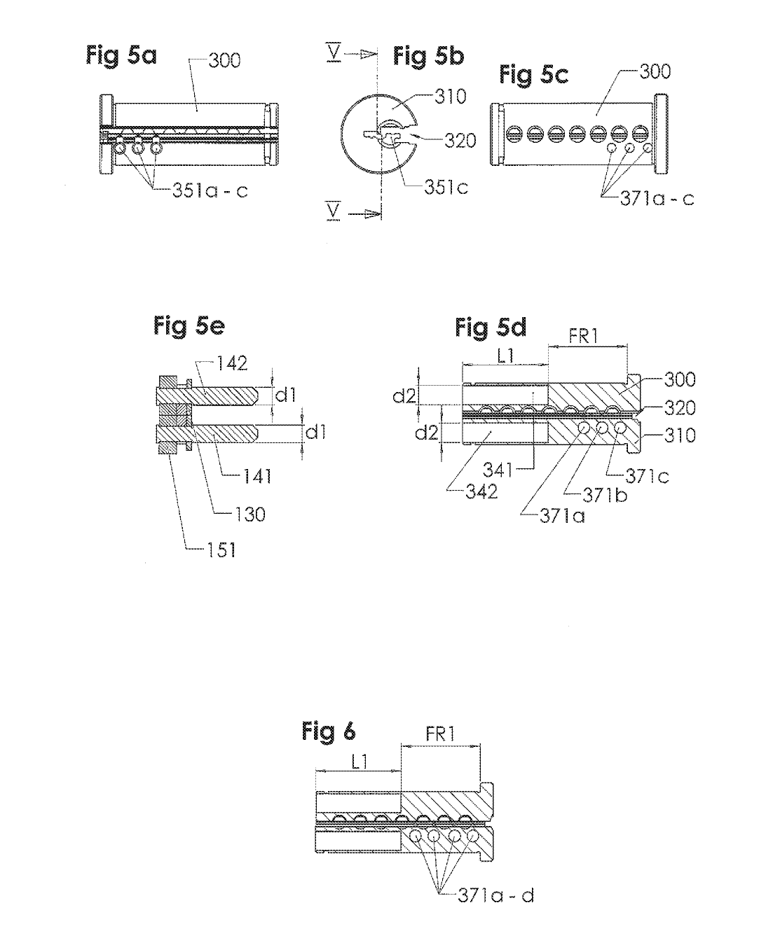

A first embodiment of the invention is shown in FIGS. 1, 2a, 2b, 3a, 3b, 4a, 4b, 4f, 5a, 5b, 5c, 5d and 5e, including a lock unit 100 and an interchangeable cylinder lock core 200 with a rotatable key plug 300 (FIG. 4a).

The lock unit 100 comprises a cylindrical housing 110 having a threaded rear end portion 110a and a slightly conical front end portion 110b. In a circular hole (not shown specifically) in a rear end wall 120, there is journaled a rotatable plate 130 provided with two parallel rods or prongs 141, 142, which extend in a direction towards the front end portion at the inside of the cylindrical housing 110, and a cam 151 (see FIG. 3b) at the back side of the rear end wall 120. The prongs 141, 142 are coupled to the cam 151 via the plate 130, so that a torque can be transferred from the prongs to e.g. a door lock mechanism.

The lock unit 100 is normally permanently mounted in a door or the like in order to cooperate with a door locking mechanism, as is well known per se. The front end of the lock unit 110 is provided with a front opening 110c, 110d having the general shape of the digit “8”, leading in to the interior of the housing with the rear prongs 141, 142.

The interchangeable cylinder lock core 200 (see FIG. 2a) comprises a shell 210, also having the shape of the digit “8” and being dimensioned to fit with a slight play into the front opening 110c, 110d of the housing 110 of the lock unit 100, as will be seen in FIGS. 2a, 2b and FIGS. 3a, 3b. The shell 210 includes, in this embodiment, an upper, solid part 220 and a lower part 230 with two axially spaced hollow sleeve portions 240, 241 and a middle retainer sleeve 250 therebetween.

The upper, solid part 220 of the shell 210 has a central row of parallel cavities or holes 221a, 221b, 221c, 221d, 221e, 221f and 221g, the number of cavities being seven in this particular embodiment. As will be shown below, other normal embodiments are provided with six such cavities in a central row. At the upper side, a longitudinal cover plate 222 will noanally cover the holes 221a, etc. from above and keep a corresponding number of locking pins 231a, etc., 232a, etc. and associated springs 235a, etc. in place.

In the hollow sleeve portions 240, 241 and the middle retainer sleeve 250, a key plug 300 is rotatably mounted. A front end wall 310 of the key plug is visible in FIGS. 1 and 2a, but the whole key plug is seen best in FIGS. 4a, 5a, 5b, 5c and 5d. The outer diameter of the cylindrical key plug is slightly smaller than the inside diameters of the sleeve portions 240, 241 and the middle retainer sleeve 250, so that the key plug can rotate in relation to the shell 210. However, the possible rotary motion of the key plug is dependent on the positions of locking pins 231a, 231b, 231c, 231d, 231e, 231f, 231g shown in FIG. 4a and being movable in associated vertical cavities or holes 331a, 331b, 331c, 331d, 331e, 331f, 331g arranged in a central longitudinal row in the upper solid part 220 of the shell 210. These vertical holes 331a, etc. are located above a central keyway 320. The locking pins 231a etc. are held in place by associated top pins 232a, 232b, 232c, 232d, 232e, 332f, 232g (collectively denoted 232a-232g in FIG. 4a) and corresponding helical springs 235a, 235b, 235c, 235d, 235e, 235f, 235g (collectively denoted 235a-235g in FIG. 4a). In the three pin assemblies in the middle, there are also three short pins or wafers 233c, 233d, 233e which cooperate with the retainer sleeve 250. The latter is provided with three associated cavities or holes 251c, 251d, 251e, so that these short pins can be positioned exactly in these holes 251c, etc. to make it possible to rotate the retainer sleeve 250 by inserting a control key (not shown, denoted “first key” in the claims). When the retainer sleeve is rotated by turning such a control key, a holding lug 260 with a stop end surface 260a will lose its engagement with an inner shoulder 160 (FIG. 2b) at the inside of the housing 110 of the lock unit 100, so that the interchangeable cylinder lock 200 with its key plug 300 can be taken out as a unit (the interchangeable cylinder lock core 200, 300) from the lock unit 100.

In the normal operation of the cylinder lock, a correctly cut key 40 (denoted “second key” or just “key” in the claims) will operate the interchangeable cylinder lock 200 so as to rotate the key plug 300 and turn the rear cam 151 by means of the prongs 141, 142 (see also FIG. 5e), which are securely guided within associated prong holes 341, 342 (FIG. 5d) in the key plug 300. The diameter d1 of the prongs is normally about 3.2 mm, and the inner diameter d2 of the prong holes are normally about 3.4 mm, leaving a slight radial play of 0.1 mm therebetween.

In accordance with the present invention, the two prong holes should both have a minimum length L1 (see FIG. 5d), preferably the same length, of at least half of the length (L1+FR1) of the key plug, corresponding to about 4 times the diameter d2 of each prong hole 341, 342. Then, it has turned out that the prongs 141, 142 will be effectively guided when the interchangeable cylinder lock core is inserted into the housing of the lock unit and that, during use, the two prongs will be securely engaged in the prong holes when the key plug Is being rotated while transferring a torque for operating the lock. So, it is important that there are two prong holes having such a minimum length L1 in the back region of the key plug.

Also, the key plug is provided with an auxiliary side locking mechanism which is located on at least one lateral side of the keyway 320 and which is confined entirely within a front region FR1 located longitudinally in front of and adjoining the prong holes 341, 342 (see FIGS. 5a, 5b, 5c, 5d, 5e). Preferably, this front region FR1 is substantially solid, except for the keyway, the cavities for the locking pins and any recesses and holes for accommodating the side locking mechanism itself. According to the invention, the side locking mechanism should comprise at least two independently movable side locking tumblers providing a high security mechanism with at least three different code positions for each locking tumbler and a plurality of different code combinations for the side locking tumblers. In the embodiment described above, see FIGS. 4a, 4f, 4k, 5a, 5b, 5c, 5d and 5e, the side locking mechanism includes three locking tumblers 351a, 351b, 351c which are arranged in a row at one side of the keyway 320 of the key plug 300, in the solid front region thereof. This front region FR1 is generally defined as a region located in front of and adjoining the back region with the prong holes 341, 342. The three locking tumblers are located entirely within this front region and also radially inside the fixed front sleeve portion 241. This location of the side locking mechanism 351a, 351b, 351c has the advantage that it will interact mainly with the fixed front sleeve portion 241, in associated recesses or holes 242, next to the front end 310 of the key plug 300. Other embodiments are possible, as will be described below.

The three side locking tumblers 351a, 351b, 351c are biased by springs 361a, 361b, 361c (collectively denoted 361a-361c in FIG. 4a) in associated vertical cavities or holes 371a, 371b, 371c (collectively denoted 371a-371c in FIG. 4a) at some lateral distance from the keyway 320 so as to project into the keyway with a projecting finger (visible in FIG. 5b) which will cooperate with a wave-like side code pattern 41 on the key blade of the key 40. When the key 40 is inserted into the keyway 320, the locking tumblers 351a, etc. will move up and down in response to their contact with the side code pattern 41. The lower ends of the tumblers 351a, etc. will then interact with the associated recesses or holes 242 in the fixed sleeve portion 241. At the same time, the bittings of the upper edge portion 42 of the key 40 will interact with the central row of locking pins 231a, etc. Only when all of the locking pins 231a, etc. and the three side locking tumblers 351a, etc. are correctly positioned, totally within the circumference of the key plug 300, will it be possible to turn the operating key 40 (the “second key”) so as to open the cylinder lock.

It is important that the side tumblers 351a, etc. are movable independently of the central locking pins 231a, etc. Thus, if the cylinder lock is manipulated with a so called “bumping” technique, it may be possible to position all the locking pins 231a, but it will be much more difficult to simultaneously manipulate the locking tumblers 351a, etc. into their respective coded positions. Thus, the side locking mechanism 351 will provide a high security for the cylinder lock core.

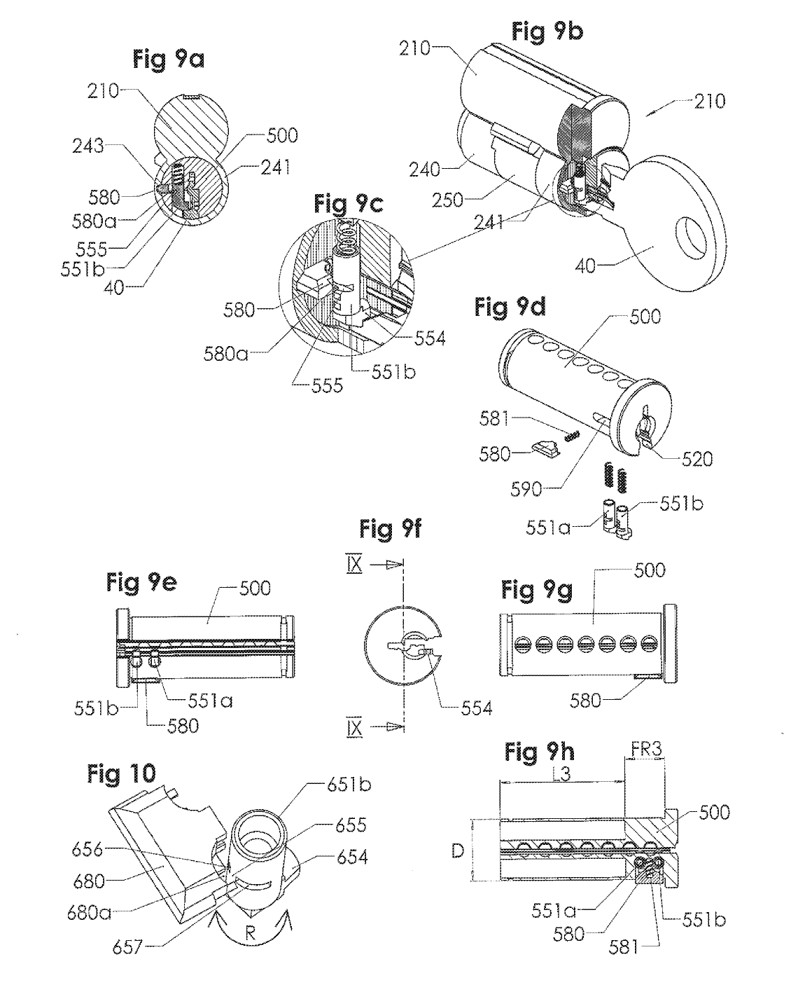

As a modification of the first embodiment described above, as shown in FIGS. 4c and 4g, the retainer sleeve 250′ may extend along the inside of the lower part of the shell 210 all the way from the back end of the key plug 300 to a location at a distance from the front end thereof. In such an embodiment, the lower, fixed part of the shell 210′ may be constituted by a front sleeve portion 241′, which is similar to the front sleeve portion 241 in FIG. 4a and is provided with lower recesses or holes 242′. The fixed front sleeve portion 241′ may have the same longitudinal length as the fixed front sleeve portion 241 or it may be shorter, possibly corresponding to a relatively short front region FR3 (see FIG. 9h) of the key plug. The rotatable retainer sleeve 250′ may be relatively long, but in this embodiment, it will make room for a fixed front sleeve portion 241′. In this embodiment, there are six central pins and six associated central holes, and the wall thickness of the fixed front sleeve portion 241′ is large enough to accommodate the recesses or holes 242′ which interact with the side locking tumblers 351a, etc. of the side locking mechanism in the key plug.

A further modification of the first embodiment shown in FIG. 4a is illustrated in FIG. 4d and FIG. 4h. Here, the fixed front end sleeve portion 241″ has a relatively thick cylindrical wall (e.g. the same as in FIG. 4a and FIG. 4c) with recesses or holes 242″ but is integrated, preferably in one piece, with a fixed rear end sleeve portion 240″ having a smaller radial thickness in its cylindrical wall. The relatively long rotatable retainer sleeve 250″ is mounted radially inside the fixed rear end sleeve portion 240″ and also has a thin cylindrical wall, so that its interior bore has the same diameter and is aligned with the interior bore of the fixed front end sleeve portion. In this embodiment as well, the retainer sleeve can be rotated or turned in relation to the lower part of the shell with its fixed front and rear end portions. The front region of the key plug is confined longitudinally within the front end sleeve portion 241″ having a relatively thick cylindrical wall.

Another embodiment is shown in FIGS. 4e and 4i, where the rotatable retainer sleeve 250′″ as well as the surrounding fixed sleeve 241′″ both have the same length as the key plug 300, with seven central pins and associated central holes, and have rather thin cylindrical walls, the retainer sleeve 250′″ being rotatable inside the fixed sleeve 241′″. Both of these sleeves are provided with lower holes or recesses 242′″ and through-going holes 252′″, respectively, interacting with the side locking tumblers 351a, etc. of the key plug.

The interaction between the side locking tumbler 351b of the key plug 300 and the surrounding sleeve portions is illustrated further in the FIGS. 4k through 4q, where FIG. 4k shows the embodiment of FIG. 4a, and the other FIGS. 4l through 4q show the embodiment of FIG. 4e and FIG. 4i.

In FIG. 4k, the side locking tumbler 351b is located in its totally retracted position within the key plug, where both of its ends are located at the shear line between the key plug 300 and the surrounding fixed sleeve portion 241, and the central pin 231f is also located with its upper end being located flush with the shear line. In this position, the key plug can be rotated or turned, provided that all other central pins and side locking tumblers are also confined within the key plug. It can also be seen that the stop end surface 260a of the holding lug 260 of the retaining sleeve 250 projects into its retaining, projecting position, so that the whole interchangeable cylinder lock 200, 300 is securely retained within the lock unit.

The FIGS. 4l, 4m and 4n show three differently coded side locking tumblers 351a, 351b and 351c, where the transversally projecting fingers 354a, 354b and 354c are located at three different heights above the lower ends of the tumblers. This will have the consequence that when the key is withdrawn from the keyway, the lower ends of the side locking tumblers 351a, 351b, 351c will fall down to three different levels in the holes 242′″ in the fixed sleeve 241′″, as illustrated in FIGS. 4o, 4p and 4q. Since each side locking tumbler 351a, 351b, 351c has three possible codes, in this example, the total number of codes for the side locking mechanism will be 3×3×3=27 in this case.

A number of embodiments of the side locking mechanism in the interchangeable cylinder lock core according to the invention will now be described.

In FIGS. 5a, 5b, 5c, 5d, 5e, the basic (first) embodiment of FIGS. 4a, 4f and 4k is shown, with three side locking tumblers 351a, 351b, 351c in a longitudinal row in associated holes 371a, 371b, 371c on one lateral side of the keyway 320, as described above.

In a modified version of the first embodiment, as shown in FIG. 6, there are four side locking tumblers in a longitudinal row, in associated holes 371a, 371b, 371c, 371d. The back end L1 and the front end FR1 of the key plug are just as long as in the previous embodiment, and the prong holes are also exactly the same.

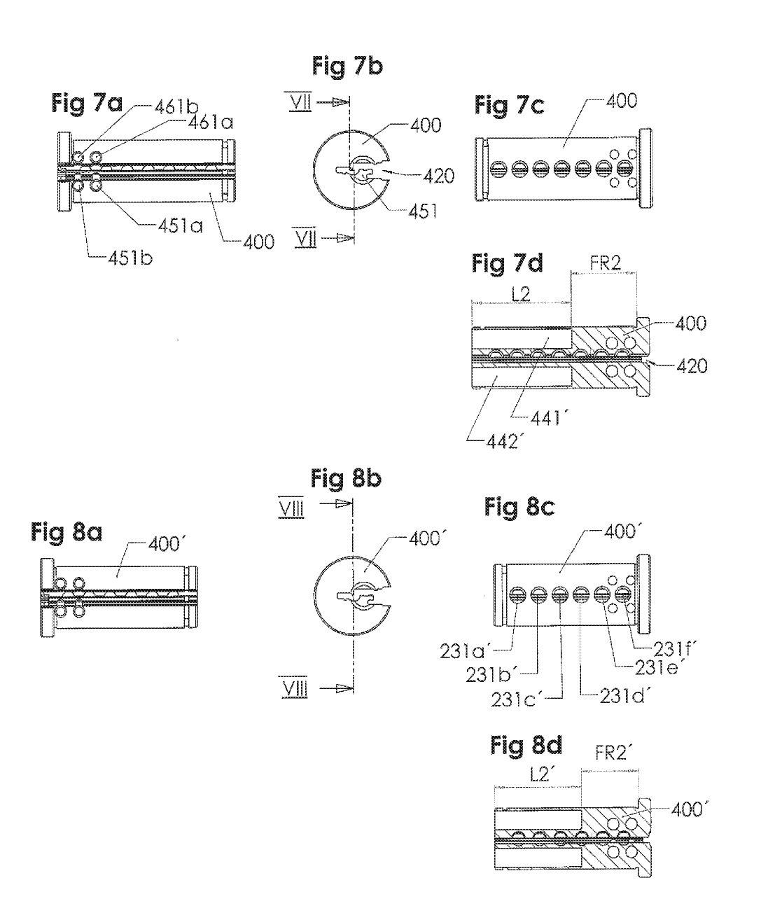

In a second embodiment, illustrated in FIGS. 7a, 7b, 7c and 7d, the structure is similar to the first embodiment (all the reference numerals starting with the digit 4 instead of 3), but here there is a row of side locking tumblers on each side of the keyway 420, each such row consisting of two independently movable side locking tumblers 451a, 451b and 461a, 461b, respectively. Each side locking tumbler will interact with the surrounding fixed sleeve portion (not shown) in the same way as shown in FIGS. 4l to 4q. Thus, there are four side locking tumblers which are movable independently of each other, each in at least three elevational positions. So, the number of possible code combinations will be even higher in this embodiment (at least 3×3×3×3=81).

The back end L2 of the key plug 400 is somewhat longer in this second embodiment, and the front end FR2 is shorter (the total length L2+FR2 being the same as in FIG. 5d).

In a modified version of the second embodiment, shown in FIGS. 8a, 8b, 8c and 8d, the structure is exactly the same as in the one shown in FIG. 7a, etc., except that the number of central locking pins 231a′, . . . 231f (FIG. 8c) in the key plug 400 is six rather than seven and the total length of the key plug is a little shorter. Still, the length L2′ of the prong holes is slightly more than half of the length of the key plug.

In a third embodiment, shown in FIGS. 9, 9a, 9b, 9c, 9d, 9e, 9f, 9g, 9h and FIG. 10, the number of central locking pins is again seven, like in most of the previous embodiments, but the side locking mechanism is different, with only two side locking tumblers, on one side of the key plug 500 only, these two side locking tumblers 551a, 551b cooperating with a relatively short side bar 580 (FIG. 9d). Such a side locking mechanism with a side bar is known per se, but not in the context of interchangeable cylinder lock cores having two relatively long prong holes. The side bar 580 is normally held in a longitudinal recess or groove 243 (see FIG. 9a) by a spring 581 (see FIG. 9d), located between the two side locking tumblers to save longitudinal space, in a position where it projects sideways outside the contour of the key plug 500. In this position, the side bar will register with the corresponding groove 243 in the front end sleeve portion 241 of the shell 200 and thereby effectively lock the key plug against rotation. However, when the side locking tumblers 551a and 551b are positioned in certain vertical positions, by means of the properly cut key 40, the side bar 580 can be moved sideways, against the action of the spring 581, into a retracted position where it is no longer seated in the groove 243. Thus, by turning the key 40, the side bar 580 will be retracted and permit rotation of the key plug 500. Then, a projecting lug 580a will find its way into a coded recess 555 in the cylindrical surface of the side locking tumbler 551b. This interaction will be seen clearly in the enlarged view in FIG. 9c, which also shows how the transverse finger 554 of the side locking tumbler 551b will be lifted to the right position by the side code pattern on the key 40. By way of the side bar, the side locking mechanism will provide a high degree of security, since it is difficult to manipulate the side locking tumblers 551a, 551b so as to release the lock. In this embodiment, with only two side locking tumblers in a row, the back region of the key plug 500 may have a greater length L3, as shown in FIG. 9h, leaving only a relatively short front region FR3.

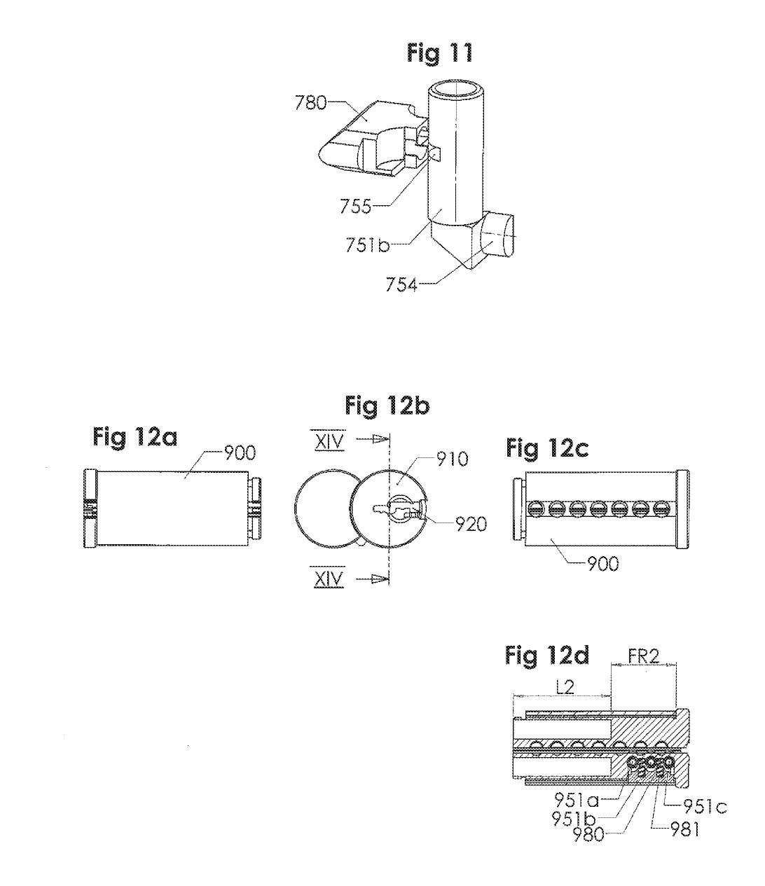

As shown in FIGS. 10 and 11, each side locking tumbler can interact in different ways with the side bar, either by way of rotating along its axis or being non-rotatable and having a longitudinally displaced finger. In FIG. 10, the side locking tumbler 651b can rotate between two rotary end positions, as indicated by the arrow R. A material portion 655, between two adjacent recesses 656, 657 in the cylindrical surface of the side locking tumbler can fit into a corresponding slot 680a in the side bar 680. With two or three rotary positions and three or more levels of the coded recesses 656, 657, the code combinations for each locking tumbler 651b will be 6 or higher. In this case, the code pattern at the side of the key must be configured to accommodate for two or three different pivotal positions of the transverse finger 654.

Similarly, in FIG. 11, the transverse finger 754 of the side locking tumbler 751b, is longitudinally displaced (along the longitudinal axis of the keyway of the key plug) into one of three coded positions. Accordingly, with several possible levels of the recesses 755 at the cylindrical surface of the tumbler, there will also be a large number of code combinations for each side locking tumbler, e.g. 9 or higher.

In a modified version of the third embodiment, shown in FIGS. 12a, 12b, 12c, 12d, there are three side locking tumblers 951a, 951b, 951c (on one side of the keyway 920 of the key plug 900) which interact with a somewhat longer side-bar 980, biased by springs 981.

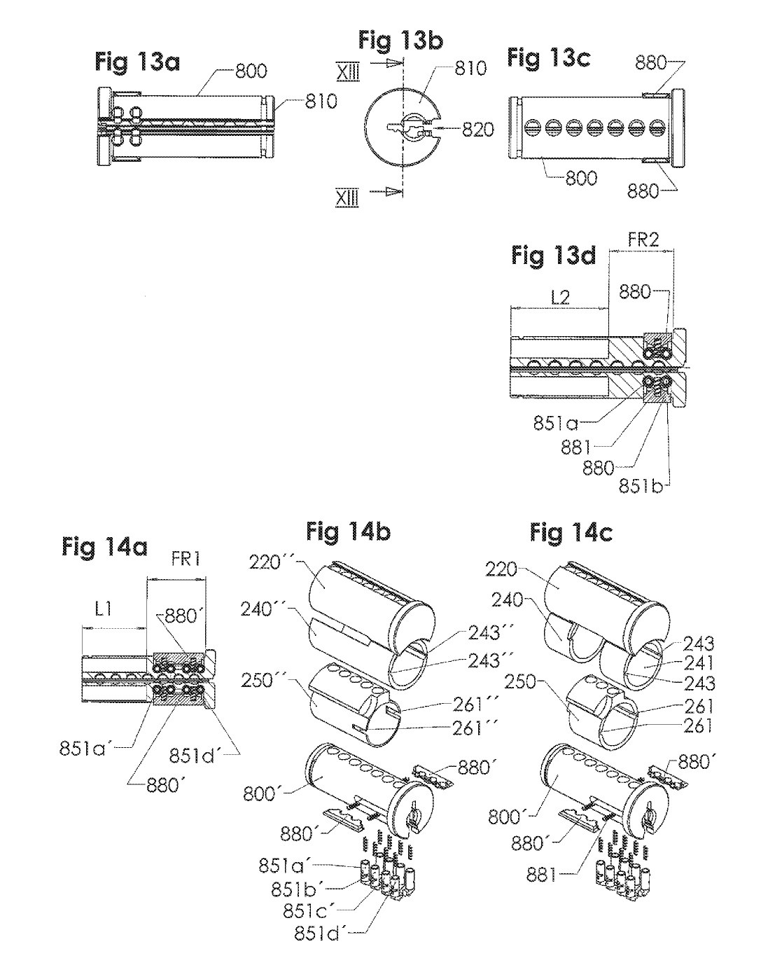

In a fourth embodiment, shown in FIGS. 13a, 13b, 13c and 13d, there are two relatively short side locking mechanisms 880, one on each side of the keyway 820, adjacent to the front end 810 of the key plug 800. This is a favorable embodiment with a very high number of code combinations and yet a compact structure confined within a rather small part (less than 20%) of the total length of the key plug 800. The back region has a relatively long length L2 and the front region is relatively short, with length FR2, but if necessary, the front region of the key plug may be just as short as in the embodiment shown in FIG. 9h (FR3).

Finally, a fifth embodiment is shown in FIGS. 14a, 14b and 14c where the key plug 800′, in its solid front end region FR1, is provided, on each side of the keyway, with a row of four side locking tumblers 851a′, 851b′, 851c′, 851d′ cooperating with an associated side bar 880′. Here, since the side locking mechanisms are arranged on both lateral sides of the keyway, each with four side locking tumblers in a row, the result will be a very large number of code combinations.

FIGS. 14b and 14c show the two possible shell structures for the fifth embodiment. In FIG. 14b, the shell structure is similar to the one shown in FIG. 4d, with an extra slot 261″ on both sides of the retainer sleeve 250″ for accommodating a rear end portion of the side bar 880′ when the latter is located in its locking position where it is seated in the respective groove 243″ in the lower fixed sleeve 240″. In FIG. 14c, the structure is similar to FIG. 4a, with a rotatable retainer sleeve 250 situated between fixed rear and front end sleeve portions 240, 241. Here, there are also grooves 243 and 261 interacting with the side-bars 880′.

The side-bars shown in FIGS. 9a to 9h, 10, 11, 12d, 13d and 14a to 14c are very favorable in that the springs (e.g. 581 in FIG. 9d), which push the side-bar radially outwardly, are each located between a pair of side locking tumblers, so that the end of the side-bar can be positioned very close to the front end of the key plug, thereby saving space.

Also, in all embodiments, the hole (e.g. 371c) for the side locking tumbler (e.g. 351c) being located closest to the front end of the key plug is located closer to the front end than all the central holes (e.g. 331a-331g), whereby the space for the side locking mechanism is utilized efficiently, and there is consequently room for at least two and possibly three or four side locking tumblers in a row in the front region FR1, FR2, FR3 which is at the most half of the total length of the key plug.

The associated key 40, having a wave-like side code pattern 41 (see FIG. 4b) with code portions interacting with the side locking tumblers, will have the entire side code pattern 41 located substantially within the half of the key blade being located closest to the grip portion of the key. Furthermore, the side code portion of this pattern 41 located closest to the grip portion will be located closer to the grip portion than all the V-shaped bittings 42 on the edge of the key, the latter bittings interacting with the central row of locking pins of the cylinder lock. In this way, these keys 40 will be distinguished from all prior art keys.

As illustrated in FIGS. 1-14c, an interchangeable cylinder lock core (200) is provided with a rotatable cylindrical key plug (300; 300; 400′; 500; 800; 800′; 900) for use together with a lock unit (100) having a housing (110) dimensioned to receive the interchangeable cylinder lock core. A torque transferring mechanism is provided in the housing adapted to transfer a torque to the lock unit when the key plug is rotated. The torque transferring mechanism may include two longitudinal prong holes (341, 342; 441′, 442′) that extend from the back end of the key plug (300) for receiving two longitudinal prongs (141, 142). In the alternative, the torque transferring mechanism may be a projection extending from the rotatable plate 130 that is received in an aperture in the back end of the key plug (300) to transfer the torque of the lock unit when the key plug is rotated.

A shell (210) is provided having an outer contour dimensioned to fit into the housing (110). The shell includes an upper part (220, 220′, 220″; 220′″), provided with a central row of locking pins (231a, . . . , 231g) in associated cavities (221a, . . . , 221g), and a lower part (230) with a cylindrical bore accommodating the rotatable key plug, at least a part of the cylindrical bore extending through a rotatable retainer sleeve (250). The rotatable key plug is also provided with a central row of associated cavities (331a, . . . , 331g) cooperating with the locking pins. In addition, the rotatable retainer sleeve is provided with holes (251c, 251d, 251e) corresponding to the cavities (331a, 331b, 331c) for the locking pins and also is provided with an engaging member (260), adapted to releasably retain the interchangeable cylinder lock core in the housing, and to enable removal and replacement of the interchangeable cylinder lock core in relation to the housing (110) of the lock unit.

The key plug (300; . . . ; 900) is rotatable in the cylindrical bore and includes a back region (L1; L2; L3) extending from a back end, and a front region (FR1; FR2, FR3), which adjoins the back region and extends up to a front end (310) of the key plug. A keyway (320, 420, 520) extends from the front end axially along the key plug and is configured to accommodate an associated key (40).

The central row of locking pins (231a, . . . , 231g) is arranged to engage with and lock the key plug (300; . . . ; 900) against rotation in the lower part of the shell (200, 200′) unless the associated key (40) is inserted into the keyway.

The adjoining front region (FR) of the key plug accommodates, in addition to the central row of locking pins, at least one side locking mechanism (351c, 351b, 351a; 451a, 451b, 461a, 461b; 551a, 551b, 580, 851a′-851d′, 880′; 951a, 951b, 951c, 980) on at least one lateral side thereof so as to engage with an inner circumferential surface of a fixed front end sleeve portion (241; 241′; 241″; 241″), which forms a portion of the lower part (230) of the shell. The at least one side locking mechanism (351c, 351b, 351a) is operative independently of the central row of locking pins (231a, 231b, 231c). In addition, the at least one side locking mechanism includes a longitudinal row of at least two coded side locking tumblers (351a, 351b, 351c) which are each movable independently of each other, there being at least three different code positions for each coded side locking tumbler and a plurality of different code combinations for the at least two side locking tumblers in the longitudinal row.

As illustrated in FIGS. 4a, 5a, 5c, 5d, 6, 7a, 7c, 8a, 8c, 8d, 9e, 9h, 12d, 13a, 13c and 14a, at least one of the coded side locking tumblers (351c, 371c, 371d, 451b, 461b, 551b, 951c, 851b, 851d′) is located in front of the first one (331g, 231f′) of the associated cavities (331a, . . . , 331g; 231a′ . . . , 231f) disposed adjacent to the front end (310) of the key plug.

As illustrated in FIG. 2a, the rotatable retainer sleeve (250) is arranged between the fixed front end sleeve portion (241) and a rear end sleeve portion (240), the sleeve portions defining the cylindrical bore together with the rotatable retainer sleeve. As illustrated in FIGS. 4c-4e, the rotatable retainer sleeve (250′; 250″; 250′″) extends from the back end of the key plug (300) up to the fixed front end sleeve portion (241, 241′, 241″, 241′″). The rotatable retainer sleeve (250″; 250′″) has a thinner cylindrical wall than the fixed front end sleeve portion (241″; 241′″) and the fixed front end sleeve portion (241″) is integrated with a rear end sleeve portion (240″; 240′″) having a thinner cylindrical wall than the front end sleeve portion (241″; 241′″), the rear end sleeve portion (240′; 240′″) being located radially outside the rotatable retainer sleeve (250″; 250′″) such that the retainer sleeve (250″; 250′″) and the front end sleeve portion (241″; 241′″) define the cylindrical bore.

As illustrated in FIG. 2b, the rotatable retainer sleeve (250) has a holding lug adapted to engage, upon insertion of the interchangeable cylinder lock core into the lock unit (100), with a recess having a shoulder (160) at the inside of the housing (110) of the lock unit (100), the holding lug on the rotatable retainer sleeve having a stop end surface being located longitudinally at the front end of the rotatable retainer sleeve.

As illustrated in FIGS. 14a-14c, the fixed front end sleeve portion (241) as well as the rotatable retainer sleeve portion (250) are provided with recesses (242, 252, 243, 243″) at their inside cylindrical surfaces for accommodating radially projecting parts (351a, 351b, 351c, 880′) of the at least one side locking mechanism.

As illustrated in FIGS. 7a, 7c, 7d, 8a, 8c, 8d, 13a, 13d, 14a-14c) the at least one side locking mechanism (451a, 451b, 461a, 461b; 851a, 851b, 880; 851a′-851d′, 880′) is provided on each side of the keyway (420; 820) wherein at least one of the locking tumblers (351c, 851b) is located in front of the first cavity (331g) of the key plug (400; 800).

As illustrated in FIGS. 4m, 4p and 9c, each of the coded side locking tumblers (351b, 551b) in the front region of the key plug (300, 500) is provided with a transverse finger (354b, 554) being held in direct contact with a side code pattern (41) on the associated key (40).

At least two each of the coded side locking tumblers (351b, 351c) are movable between a coded releasing position where they are totally confined within the key plug (300), and at least one locking position where they project radially outside the key plug and engage with the inside of the fixed front end sleeve portion (241), whereby it will prevent rotation of the key plug (300).

As illustrated in FIGS. 9d, 9e, 9h, 12d and 13d, the coded side locking tumblers (551a, 551b; 851a, 851b; 951a, 951b, 951c) in each side locking mechanism cooperate with an associated side bar (580; 880; 880′; 980) located at the cylindrical outer circumference of the key plug (500; 800; 900) and are adapted to engage with an associated groove (243) at the inside of the fixed front end sleeve portion (241), so as to prevent rotation of the key plug unless a correctly cut key is inserted into the keyway. The side bar is then seated inside the circumferential contour of the key plug.

As illustrated in FIGS. 9c, 10 and 11, each of the coded side locking tumblers (551b; 651b; 751b) is provided with a transverse finger (554; 654; 754) cooperating with a side code pattern on an associated key, and with at least one recess (555, 657, 755) in an outside portion thereof at a distance from the transverse finger, adapted to cooperate with the side bar (580; 680; 780), so as to enable the latter to disengage from the groove (243) at the inside of the front end sleeve portion (241). As illustrated in FIG. 11, the transverse finger (754) is longitudinally displaced, along the keyway, to form a coded location, in relation to a central axis of the associated coded side locking tumbler (751b), with each locking tumbler being coded both in respect of the longitudinal displacement of the transverse finger with the location of the at least one recess (755) cooperating with the side bar (780).

As illustrated in FIG. 10, each of the coded side locking tumblers (651b) is movable up and down or elevationally as well as rotationally in an associated cavity, the rotational position also forming a code.

As illustrated in FIGS. 13d and 14a-14c, the key plug is provided with two side locking mechanisms each having a side bar (880; 880′), one on each side of the keyway.

As illustrated in FIG. 4a, the at least one coded side locking mechanism may extend backwards from the area adjacent to the first cavity (331g).

As illustrated in FIG. 14b, the at least one side locking mechanism interacts also with the rotatable retainer sleeve (250″) which is provided with a longitudinally extending recess (261″) for accommodating a radially projecting part (880′) of the at least one side locking mechanism.

As illustrated in FIGS. 1, 2b, 4a, 4c and 4d, the row of locking pins (231a-231g) in the upper part (220) of the shell comprises six or seven locking pins adapted to cooperate with bittings on an edge portion (42) of the associated key (40) being inserted into the keyway (320). The rotatable retainer sleeve (250; 250′; 250″) has a holding lug (260) adapted to engage, upon insertion of the interchangeable cylinder lock core into the lock unit (100), with a recess having a shoulder (160) at the inside of the housing (110) of the lock unit (100). The holding lug (260) on the rotatable retainer sleeve includes a stop end surface (260a) being located longitudinally at the front end of the rotatable retainer sleeve.

As illustrated in FIGS. 9a-9h, 12a-12d, 13a-13d and 14a-14c, an interchangeable cylinder lock core with a rotatable cylindrical key plug (500; 800; 800′; 900) is provided for use together with a lock unit having a housing dimensioned to receive the interchangeable cylinder lock core, and includes a torque transferring mechanism in the housing adapted to transfer a torque to the lock unit when the key plug is rotated.

As illustrated in FIGS. 9a and 9b, the interchangeable cylinder lock core includes a shell (210) having an outer contour dimensioned to fit into the housing. As illustrated in FIGS. 4f-4i, the shell includes an upper part (220; 220″; 220′″) is provided with a central row of locking pins in associated cavities and a lower part with a cylindrical bore accommodating the rotatable key plug. At least a part of the cylindrical bore extends through a rotatable retainer sleeve (250, 250″). The rotatable key plug is also provided with a central row of associated cavities cooperating with the locking pins.

The rotatable retainer sleeve is provided with holes corresponding to the cavities for the locking pins and is also provided with an engaging member, adapted to releasably retain the interchangeable cylinder lock core in the housing, and to enable removal and replacement of the interchangeable cylinder lock core in relation to the housing of the lock unit. The key plug (500; . . . ; 900) is rotatable in the cylindrical bore and having a back region (L2; L3) extending from a back end, and a front region (FR2, FR3), which adjoins the back region and extends up to a front end of the key plug. A keyway (520) extends from the front end axially along the key plug and is configured to accommodate an associated key (40).

The central row of locking pins is arranged to engage with and lock the key plug against rotation in the lower part of the shell unless the associated key (40) is inserted into the keyway. The adjoining front region (FR2, FR3) of the key plug accommodates, in addition to the central row of locking pins, at least one side locking mechanism (551a, 551b; 580; 851a′-851d′; 880′; 951a, 951b, 951c; 980) on at least one lateral side thereof so as to engage with an inner circumferential surface of a fixed front end sleeve portion (241), which forms a portion of the lower part of the shell. The at least one side locking mechanism is operative independently of the central row of locking pins.

As illustrated in FIGS. 9d, 9e and 9h, the at least one side locking mechanism includes a longitudinal row of at least two coded side locking tumblers (551a, 551b) which are each movable independently of each other, there being at least three different code positions for each coded side locking tumbler and a plurality of different code combinations for the at least two side locking tumblers in the longitudinal row.

The longitudinal row of at least two coded side locking tumblers cooperate with an associated side bar (580, 880, 880′, 980), forming a part of the side locking mechanism and are adapted to engage with an associated groove (243; 243″) at the inside of the fixed front end sleeve portion (241). As illustrated in FIG. 9d, a spring (581) is disposed between the at least one pair of the locking tumblers cooperating with the side bar. At least a pair of side locking tumblers is located adjacent to the front end of the key plug.

The rotatable retainer sleeve (250) is arranged between the fixed front end sleeve portion (241) and a rear end sleeve portion (240), the sleeve portions defining the cylindrical bore together with the rotatable retainer sleeve. The rotatable retainer sleeve (250″) extends from the back end of the key plug (800′) up to the fixed front end sleeve portion.

As illustrated in FIGS. 4d, 14b and 14c, the rotatable retainer sleeve (250″) has a thinner cylindrical wall than the fixed front end sleeve portion and the fixed front end sleeve portion is integrated with a rear end sleeve portion (240″) having a thinner cylindrical wall than the front end sleeve portion, the rear end sleeve portion (240″) being located radially outside the rotatable retainer sleeve (250″) such that the retainer sleeve (250″) and the front end sleeve portion define the cylindrical bore. The fixed front end sleeve portion as well as the rotatable retainer sleeve portion (250″) are provided with recesses (243″; 261″) at the inside cylindrical surfaces for accommodating the side bar (880′) of the at least one side locking mechanism.

As illustrated in FIGS. 4k and 9c, each of the coded side locking tumblers (351b, 551b) in the front region of the key plug (300, 500) is provided with a transverse finger (354, 554) that is held in direct contact with a side code pattern (41) on the associated key (40).

Each of the coded side locking tumblers (551b; 651b; 751b) is provided with a transverse finger (554; 654; 754) cooperating with a side code pattern on an associated key, and with at least one recess (555, 657, 755) in an outside portion thereof at a distance from the transverse finger that is adapted to cooperate with the side bar (580; 680; 780), so as to enable the latter to disengage from the groove (243; 243″) at the inside of the front end sleeve portion (241; 240″).

As illustrated in FIG. 11, the transverse finger (754) is longitudinally displaced, along the keyway, to form a coded location, in relation to a central axis of the associated coded side locking tumbler (751b), each locking tumbler being coded both in respect of the longitudinal displacement of the transverse finger, and the location of the at least one recess (755) cooperating with the side bar (780).

As illustrated in FIG. 10, each of the coded side locking tumblers (651b) is movable up and down or elevationally as well as rotationally in an associated cavity, the rotational position also forming a code.

As illustrated in FIGS. 13d and 14a-14c, the key plug may be provided with two side locking mechanisms each having a side bar (880; 880′), one on each side of the keyway.

In addition, the at least one coded side locking mechanism may extend backwards from the area adjacent to the first cavity (331g).

As illustrated in FIG. 14b, the at least one side locking mechanism may interact also with the rotatable retainer sleeve (250″) which is provided with a longitudinally extending recess (261″) for accommodating the side bar (880′) of the at least one side locking mechanism.

As illustrated in FIG. 4a, the row of locking pins (231a-231g) in the upper part (220) of the shell comprises six or seven locking pins adapted to cooperate with bittings on an edge portion (42) of the associated key (40) being inserted into the keyway (320).

Those skilled in the art can modify, within the scope of the appended claims, the disclosed embodiments in many ways, for example by modifying the detailed structure of the key and the interchangeable cylinder lock core with its retainer sleeve mechanism, the central locking pins (with associated top pins and springs), the side locking tumblers, the optional side bar and the overall configuration of the upper and lower parts of the shell.

In certain cases, e.g. to allow for manufacturing tolerances or where it is desirable to have a row of more than four side locking tumblers in a seven pin cylinder or to have a row of more than three side locking tumblers in a six pin cylinder, the minimum length L1 of the prong holes may be just half of the length (L1+FR1) of the key plug.

1. An interchangeable cylinder lock core with a rotatable cylindrical key plug for use together with a lock unit having a housing dimensioned to receive said interchangeable cylinder lock core, there being a pair of prongs in said housing adapted to transfer a torque to said lock unit when the key plug is rotated, the interchangeable cylinder lock core comprising:
a shell having an outer contour dimensioned to fit into said housing,
said shell comprising an upper part, provided with a central row of locking pins in associated cavities, and a lower part with a cylindrical bore accommodating said rotatable key plug, at least a part of said cylindrical bore extending through a rotatable retainer sleeve,
said rotatable key plug also being provided with a central row of associated cavities cooperating with said central row of locking pins,
said rotatable retainer sleeve being provided with holes corresponding to said cavities for said central row of locking pins and also being provided with an engaging member, adapted to releasably retain the interchangeable cylinder lock core in said housing, and to enable removal and replacement of the interchangeable cylinder lock core in relation to said housing of the lock unit,
said key plug being formed in one piece and being rotatable in said cylindrical bore, and having a back region extending from a back end, and a front region, which adjoins said back region and extends up to a front end of the key plug;
a keyway extending from said front end axially along said key plug and being configured to accommodate an associated key,
said central row of locking pins being arranged to engage with and lock the key plug against rotation in said lower part of said shell unless said associated key is inserted into said keyway,
there being two longitudinal prong holes extending along the whole length of said back region of the key plug from said back end thereof so as to provide, in use together with said lock unit, an effective guiding of said prongs and a secure engagement of the two prongs in said prong holes, when the key plug is being rotated while transferring a torque onto said two prongs,
wherein:
said back region of the key plug, accommodating said two longitudinal prong holes, has a minimum length of at least half of the length of the key plug, the adjoining front region of the key plug, located in front of said longitudinal prong holes, thus having a length being no longer than half of the length of the key plug,
said adjoining front region accommodates, in addition to said central row of locking pins, at least one side locking mechanism, which is located in its entirety within said front region of the key plug and is adapted to interact with at least one recess in a fixed front end sleeve portion,
said fixed front end sleeve portion, forming a portion of said lower part of said shell, is located radially outside said front region of the key plug and is provided with at least one recess for receiving and engaging with at least one radially projecting part of said at least one side locking mechanism,
said at least one side locking mechanism is operative independently of said central row of locking pins, and is disposed on at least one lateral side of said keyway, and
each said at least one side locking mechanism comprises a longitudinal row of at least two coded side locking tumblers which are movable independently of each other, there being at least three different code positions for each coded side locking tumbler and a plurality of different code combinations for the at least two side locking tumblers in said longitudinal row in said front region of the key plug.

2. An interchangeable cylinder lock core as defined in claim 1, wherein said longitudinal row of side locking tumblers in said side locking mechanism comprises at least three side locking tumblers.

3. An interchangeable cylinder lock core as defined in claim 1, wherein
said rotatable retainer sleeve is arranged axially between said fixed front end sleeve portion and a rear end sleeve portion, said fixed sleeve portions defining said cylindrical bore together with said rotatable retainer sleeve.

4. An interchangeable cylinder lock core as defined in claim 1, wherein
said rotatable retainer sleeve extends from said back end of said key plug up to said fixed front end sleeve portion.

5. An interchangeable cylinder lock core as defined in claim 4, wherein said rotatable retainer sleeve has a thinner cylindrical wall than a cylindrical wall of said fixed front end sleeve portion and said fixed front end sleeve portion is integrated with a fixed rear end sleeve portion having a thinner cylindrical wall than said front end sleeve portion, said fixed rear end sleeve portion being located radially outside said rotatable retainer sleeve such that the rotatable retainer sleeve and said fixed rear end sleeve portion together have a wall thickness corresponding to the wall thickness of said fixed front end sleeve portion.

6. An interchangeable cylinder lock core as defined in claim 5, wherein said fixed front end sleeve portion as well as said rotatable retainer sleeve are provided with recesses at their inside cylindrical surfaces for accommodating said at least one radially projecting part of said at least one side locking mechanism.

7. An interchangeable cylinder lock core as defined in claim 1, wherein
said rotatable retainer sleeve has through-going holes or a longitudinal slot in a front region thereof, said through-going holes or longitudinal slot being dimensioned to receive said at least one radially projecting part of said side locking mechanism, and said radially projecting part of the side locking mechanism being radially longer than the thickness of the rotatable retainer sleeve in this front region so as to extend through the sleeve and engage with said at least one hole in the fixed front end sleeve portion.

8. An interchangeable cylinder lock core as defined in claim 1, wherein said key plug is provided with two side locking mechanisms, one on each side of said keyway.

9. An interchangeable cylinder lock core as defined in claim 1, wherein each of said coded side locking tumblers in said front region of the key plug is provided with a transverse finger being held in direct contact with a side code pattern on said associated key when the key is being inserted into said keyway.

10. An interchangeable cylinder lock core as defined in claim 1, wherein
at least two of said coded side locking tumblers are movable between a coded releasing position where they are totally confined within the key plug, and at least one locking position where they project radially outside the key plug and engages with said at least one recess in said fixed front end sleeve portion, whereby they will prevent rotation of the key plug.

11. An interchangeable cylinder lock core as defined in claim 1, wherein
said longitudinal row of coded side locking tumblers in each side locking mechanism cooperate with an associated side bar, forming a part of said side locking mechanism and being located at the cylindrical outer circumference of the key plug and being adapted to engage with an associated groove, forming said at least one recess, at the inside of said fixed front end sleeve portion, so as to prevent rotation of the key plug unless a correctly cut key is inserted into said keyway, the side bar being then seated inside the circumferential contour of the key plug.

12. An interchangeable cylinder lock core as defined in claim 11, wherein
each of said coded side locking tumblers is provided with a transverse finger (554; 654; 754) cooperating with a side code pattern on an associated key, and with at least one coded recess in an outside portion thereof at a distance from said transverse finger, adapted to cooperate with said side bar, so as to enable the latter to disengage from said groove at the inside of said front end sleeve portion.

13. An interchangeable cylinder lock core as defined in claim 12, wherein
said transverse finger is longitudinally displaced, along said keyway, to form a coded location, in relation to a central axis of the associated coded side locking tumbler, each locking tumbler being coded both in respect of the longitudinal displacement of the transverse finger, and the location of said at least one coded recess cooperating with said side bar.

14. An interchangeable cylinder lock core as defined in claim 12, wherein
each of said coded side locking tumblers is movable up and down as well as rotationally in an associated cavity, the rotational position also forming a code.

15. An interchangeable cylinder lock core as defined in claim 1, wherein
said rotatable retainer sleeve is positioned behind at least the first cavity disposed adjacent to the front end of the key plug.

16. An interchangeable cylinder lock core as defined in claim 15, wherein at least
one of said side tumblers is positioned in front of said first cavity and will interact with a recess in said fixed front end sleeve portion.

17. An interchangeable cylinder lock core as defined in claim 11, wherein
at least one spring is disposed between two side locking tumblers cooperating with said side bar there being no spring located between a side locking tumbler and an end of the side bar.

18. A lock and key system including an interchangeable cylinder lock core as defined in claim 1, wherein the lock and key system comprises a first key for removal and replacing the interchangeable cylinder lock core in relation to said lock unit, and at least one second key for opening the cylinder lock core while retaining the cylinder lock core in the lock unit, said at least one second key comprising a grip portion and a key blade, wherein
said key blade has an edge code pattern comprising a longitudinal continuous row of code portions defined by V-shaped bittings configured to interact with said central row of locking pins in said shell of the cylinder lock core, and
said key blade also has a wave-like side code pattern configured to interact with said at least one side locking mechanism being located in the front region of the key plug on at least one lateral side of said key plug, and
said wave-like side code pattern is confined substantially to the longitudinal half of the key blade located closest to said grip portion and comprises at least two coded portions configured to interact with said at least two side locking tumblers of said at least one side locking mechanism, so as to position, upon being inserted into said key plug, said side locking tumblers in predetermined code locations that will open the lock by permitting rotation of said key plug within the lower part of said shell, either directly by releasing the engagement of said side locking tumblers in relation to said fixed front sleeve portion of the shell of the cylinder lock core, or via a side-bar interacting with said fixed front sleeve portion of the shell of the cylinder lock core.

19. A lock and key system as defined in claim 18, wherein at least one of said code portions of the wave-like side code pattern of said second key is located closer to the grip portion of the key than all the code portions of the edge code pattern.

20. A lock and key system as defined in claim 18, wherein the side code portions of said wave-like side code pattern are arranged in a continuous row in said longitudinal half of the key blade.

21. A key for opening an interchangeable cylinder lock core with a rotatable cylindrical key plug having a side locking mechanism being confined to a front region thereof, the key comprising a grip portion and a key blade, wherein
said key blade has a wave-like side code pattern consisting of a row of at least two side code portions being substantially confined to the longitudinal half of the key blade located closest to said grip portion, said wave-like side code pattern adjoining to a straight profile groove extending towards the free end of the key blade, and
said key blade also has an edge code pattern comprising a longitudinal continuous row of code portions defined by V-shaped bittings.

22. A key as defined in claim 21, wherein at least one of said code portions of the wave-like side code pattern is located closer to the grip portion of the key than all the code portions of said edge code pattern.

23. A key as defined in claim 21, wherein the side code portions of said wave-like side code pattern are arranged in a continuous row in said longitudinal half of the key blade.

24. An interchangeable cylinder lock core with a rotatable cylindrical key plug for use together with a lock unit having a housing dimensioned to receive said interchangeable cylinder lock core, and including a torque transferring mechanism in said housing adapted to transfer a torque to said lock unit when the key plug is rotated, the interchangeable cylinder lock core comprising:
a shell having an outer contour dimensioned to fit into said housing,
said shell comprising an upper part, provided with a central row of locking pins in associated cavities, and a lower part with a cylindrical bore accommodating said rotatable key plug, at least a part of said cylindrical bore extending through a rotatable retainer sleeve,
said rotatable key plug also being provided with a central row of associated cavities cooperating with said locking pins,
said rotatable retainer sleeve being provided with holes corresponding to said cavities for said locking pins and also being provided with an engaging member, adapted to releasably retain the interchangeable cylinder lock core in said housing, and to enable removal and replacement of the interchangeable cylinder lock core in relation to said housing of the lock unit,
said key plug being rotatable in said cylindrical bore and having a back region extending from a back end, and a front region, which adjoins said back region and extends up to a front end of the key plug,
a keyway extending from said front end axially along said key plug and being configured to accommodate an associated key,
said central row of locking pins being arranged to engage with and lock the key plug against rotation in said lower part of said shell unless said associated key is inserted into said keyway,
wherein:
said adjoining front region (FR) of the key plug accommodates, in addition to said central row of locking pins, at least one side locking mechanism on at least one lateral side thereof so as to engage with an inner circumferential surface of a fixed front end sleeve portion, which forms a portion of said lower part of said shell,
said at least one side locking mechanism is operative independently of said central row of locking pins,
said at least one side locking mechanism comprises a longitudinal row of at least two coded side locking tumblers which are each movable independently of each other, there being at least three different code positions for each coded side locking tumbler and a plurality of different code combinations for the at least two side locking tumblers in said longitudinal row,
at least one of said coded side locking tumblers is located in front of the first one of said associated cavities disposed adjacent to the front end of the key plug, and
said first one of said associated cavities being located at a small distance from said front end of the key plug, said small distance being substantially less than the diameter of said first one of said associated cavities.

25. The interchangeable cylinder lock core as defined in claim 24, wherein said rotatable retainer sleeve is arranged between said fixed front end sleeve portion and a rear end sleeve portion, said sleeve portions defining said cylindrical bore together with said rotatable retainer sleeve.

26. The interchangeable cylinder lock core as defined in claim 24, wherein said rotatable retainer sleeve extends from said back end of said key plug up to said fixed front end sleeve portion.

27. The interchangeable cylinder lock core as defined in claim 26, wherein said rotatable retainer sleeve has a thinner cylindrical wall than said fixed front end sleeve portion and said fixed front end sleeve portion is integrated with a rear end sleeve portion having a thinner cylindrical wall than said front end sleeve portion, said rear end sleeve portion being located radially outside said rotatable retainer sleeve such that the retainer sleeve and said front end sleeve portion define said cylindrical bore.

28. The interchangeable cylinder lock core as defined in claim 26, wherein said fixed front end sleeve portion as well as said rotatable retainer sleeve portion are provided with recesses at their inside cylindrical surfaces for accommodating radially projecting parts of said at least one side locking mechanism.

29. The interchangeable cylinder lock core as defined in claim 24, wherein said at least one side locking mechanism is provided on each side of said keyway wherein at least one of said side locking tumblers is located in front of said first cavity (331g) of the key plug.

30. The interchangeable cylinder lock core as defined in claim 24, wherein each of said coded side locking tumblers in said front region of the key plug is provided with a transverse finger being held in direct contact with a side code pattern on said associated key.

31. The interchangeable cylinder lock core as defined in claim 24, wherein at least two of said coded side locking tumblers are movable between a coded releasing position where they are totally confined within the key plug, and at least one locking position where they project radially outside the key plug and engage with the inside of said fixed front end sleeve portion, whereby it will prevent rotation of the key plug.

32. The interchangeable cylinder lock core as defined in claim 24, wherein said coded side locking tumblers in each side locking mechanism cooperate with an associated side bar located at the cylindrical outer circumference of the key plug and being adapted to engage with an associated groove at the inside of said fixed front end sleeve portion, so as to prevent rotation of the key plug unless a correctly cut key is inserted into said keyway, the side bar being then seated inside the circumferential contour of the key plug.

33. The interchangeable cylinder lock core as defined in claim 32, wherein each of said coded side locking tumblers is provided with a transverse finger cooperating with a side code pattern on an associated key, and with at least one recess in an outside portion thereof at a distance from said transverse finger, adapted to cooperate with said side bar, so as to enable the latter to disengage from said groove at the inside of said front end sleeve portion.

34. The interchangeable cylinder lock core as defined in claim 33, wherein said transverse finger is longitudinally displaced, along said keyway, to form a coded location, in relation to a central axis of the associated coded side locking tumbler, each locking tumbler being coded both in respect of the longitudinal displacement of the transverse finger, and the location of said at least one recess cooperating with said side bar.

35. The interchangeable cylinder lock core as defined in claim 33, wherein each of said coded side locking tumblers is movable up and down or elevationally as well as rotationally in an associated cavity, the rotational position also forming a code.

36. The interchangeable cylinder lock core as defined in claim 31, wherein the key plug is provided with two side locking mechanisms each having a side bar, one on each side of said keyway.

37. The interchangeable cylinder lock core as defined in claim 24, wherein said at least one coded side locking mechanism extends backwards from the area adjacent to the first cavity.

38. The interchangeable cylinder lock core as defined in claim 37, wherein said at least one side locking mechanism interacts also with said rotatable retainer sleeve which is provided with a longitudinally extending recess for accommodating a radially projecting part of said at least one side locking mechanism.

39. The interchangeable cylinder lock core as defined in claim 24, wherein said row of locking pins in said upper part of said shell comprises six or seven locking pins adapted to cooperate with bittings on an edge portion of said associated key being inserted into said keyway.

40. The interchangeable cylinder lock core as defined in claim 24, wherein said rotatable retainer sleeve has a holding lug adapted to engage, upon insertion of the interchangeable cylinder lock core into the lock unit, with a recess having a shoulder at the inside of said housing of said lock unit, said holding lug on the rotatable retainer sleeve having a stop end surface being located longitudinally at the front end of said rotatable retainer sleeve.

41. An interchangeable cylinder lock core with a rotatable cylindrical key plug for use together with a lock unit having a housing dimensioned to receive said interchangeable cylinder lock core, and including a torque transferring mechanism in said housing adapted to transfer a torque to said lock unit when the key plug is rotated, the interchangeable cylinder lock core comprising:
a shell having an outer contour dimensioned to fit into said housing,
said shell comprising an upper part, provided with a central row of locking pins in associated cavities and a lower part with a cylindrical bore accommodating said rotatable key plug, at least a part of said cylindrical bore extending through a rotatable retainer sleeve,
said rotatable key plug also being provided with a central row of associated cavities cooperating with said locking pins,
said rotatable retainer sleeve being provided with holes corresponding to said cavities for said locking pins and also being provided with an engaging member, adapted to releasably retain the interchangeable cylinder lock core in said housing, and to enable removal and replacement of the interchangeable cylinder lock core in relation to said housing of the lock unit,
said key plug being rotatable in said cylindrical bore and having a back region extending from a back end, and a front region, which adjoins said back region and extends up to a front end of the key plug,
a keyway extending from said front end axially along said key plug and being configured to accommodate an associated key,
said central row of locking pins being arranged to engage with and lock the key plug against rotation in said lower part of said shell unless said associated key is inserted into said keyway,
wherein:
said adjoining front region of the key plug accommodates, in addition to said central row of locking pins, at least one side locking mechanism on at least one lateral side thereof so as to engage with an inner circumferential surface of a fixed front end sleeve portion, which forms a portion of said lower part of said shell,
said at least one side locking mechanism is operative independently of said central row of locking pins,
said at least one side locking mechanism comprises a longitudinal row of at least two coded side locking tumblers which are each movable independently of each other, there being at least three different code positions for each coded side locking tumbler and a plurality of different code combinations for the at least two side locking tumblers in said longitudinal row,
said longitudinal row of at least two coded side locking tumblers cooperate with an associated side bar, forming a part of said side locking mechanism and being adapted to engage with an associated groove at the inside of said fixed front end sleeve portion, and
at least one spring is disposed between two of said locking tumblers cooperating with said side bar, there being no spring located between a side locking tumbler and an end of the side bar.

42. The interchangeable cylinder lock core as defined in claim 41, wherein said rotatable retainer sleeve is arranged between said fixed front end sleeve portion and a rear end sleeve portion, said sleeve portions defining said cylindrical bore together with said rotatable retainer sleeve.

43. The interchangeable cylinder lock core as defined in claim 41, wherein said rotatable retainer sleeve extends from said back end of said key plug up to said fixed front end sleeve portion.

44. The interchangeable cylinder lock core as defined in claim 43, wherein said rotatable retainer sleeve has a thinner cylindrical wall than said fixed front end sleeve portion and said fixed front end sleeve portion is integrated with a rear end sleeve portion having a thinner cylindrical wall than said front end sleeve portion, said rear end sleeve portion being located radially outside said rotatable retainer sleeve such that the retainer sleeve and said front end sleeve portion define said cylindrical bore.

45. The interchangeable cylinder lock core as defined in claim 44, wherein said fixed front end sleeve portion as well as said rotatable retainer sleeve portion are provided with recesses at their inside cylindrical surfaces for accommodating said side bar of said at least one side locking mechanism.

46. The interchangeable cylinder lock core as defined in claim 41, wherein each of said coded side locking tumblers in said front region of the key plug is provided with a transverse finger being held in direct contact with a side code pattern on said associated key.

47. The interchangeable cylinder lock core as defined in claim 41, wherein each of said coded side locking tumblers is provided with a transverse finger cooperating with a side code pattern on an associated key, and with at least one recess in an outside portion thereof at a distance from said transverse finger, adapted to cooperate with said side bar, so as to enable the latter to disengage from said groove at the inside of said front end sleeve portion.

48. The interchangeable cylinder lock core as defined in claim 47, wherein said transverse finger is longitudinally displaced, along said keyway, to form a coded location, in relation to a central axis of the associated coded side locking tumbler, each locking tumbler being coded both in respect of the longitudinal displacement of the transverse finger, and the location of said at least one recess cooperating with said side bar.

49. The interchangeable cylinder lock core as defined in claim 41, wherein each of said coded side locking tumblers is movable up and down or elevationally as well as rotationally in an associated cavity, the rotational position also forming a code.

50. The interchangeable cylinder lock core as defined in claim 41, wherein the key plug is provided with two side locking mechanisms each having a side bar, one on each side of said keyway.

51. The interchangeable cylinder lock core as defined in claim 41, wherein said at least one coded side locking mechanism extends backwards from the area adjacent to the first cavity.

52. The interchangeable cylinder lock core as defined in claim 41, wherein said at least one side locking mechanism interacts also with said rotatable retainer sleeve which is provided with a longitudinally extending recess for accommodating said side bar of said at least one side locking mechanism.

53. The interchangeable cylinder lock core as defined in claim 41, wherein said row of locking pins in said upper part of said shell comprises six or seven locking pins adapted to cooperate with bittings on an edge portion of said associated key being inserted into said keyway.

54. The interchangeable cylinder lock core as defined in claim 41, wherein said rotatable retainer sleeve has a holding lug adapted to engage, upon insertion of the interchangeable cylinder lock core into the lock unit, with a recess having a shoulder at the inside of said housing of said lock unit, said holding lug on the rotatable retainer sleeve having a stop end surface being located longitudinally at the front end of said rotatable retainer sleeve.

55. An interchangeable cylinder lock core with a rotatable cylindrical key plug for use together with a lock unit having a housing dimensioned to receive said interchangeable cylinder lock core, there being a pair of longitudinally extending prongs in said housing adapted to transfer a torque to said lock unit when the key plug is rotated, the interchangeable cylinder lock core comprising:
a shell having an outer contour dimensioned to fit into said housing,
said shell comprising an upper part, provided with a central row of locking pins in associated cavities, and a lower part with a cylindrical bore accommodating said rotatable key plug, at least a part of said cylindrical bore extending through a rotatable retainer sleeve,
said rotatable key plug also being provided with a central row of associated cavities cooperating with said central row of locking pins,
said rotatable retainer sleeve being provided with holes corresponding to said cavities for said central row of locking pins and also being provided with an engaging member, adapted to releasably retain the interchangeable cylinder lock core in said housing, and to enable removal and replacement of the interchangeable cylinder lock core in relation to said housing of the lock unit,
said key plug being rotatable in said cylindrical bore and having a back region extending from a back end, and a front region, which adjoins said back region and extends up to a front end of the key plug;
a keyway extending from said front end axially along said key plug and being configured to accommodate an associated key,
said central row of locking pins being arranged to engage with and lock the key plug against rotation in said lower part of said shell unless said associated key is inserted into said keyway,
there being two longitudinally extending prong holes extending along the whole length of said back region of the key plug from said back end thereof so as to provide, in use together with said lock unit, an effective guiding of said two longitudinally extending prongs and a secure engagement of the two longitudinally extending prongs in said two longitudinally extending prong holes, when the key plug is being rotated while transferring a torque onto said two longitudinally extending prongs,
wherein:
said back region of the key plug, accommodating said two longitudinally extending prong holes, has a minimum length of at least half of the length of the key plug, the adjoining front region of the key plug, located in front of said two longitudinally extending prong holes, thus having a length being no longer than half of the length of the key plug,
said adjoining front region of the key plug accommodates, in addition to said central row of locking pins, at least one side locking mechanism, which is located in its entirety within said front region of the key plug and is adapted to interact with at least one recess in a fixed front end sleeve portion,
said fixed front end sleeve portion, forming a portion of said lower part of said shell, is located radially outside said front region of the key plug and is provided with at least one recess for receiving and engaging with at least one radially projecting part of said at least one side locking mechanism,
said at least one side locking mechanism is operative independently of said central row of locking pins, and is disposed on at least one lateral side of said keyway, and
each said at least one side locking mechanism comprises a longitudinal row of at least two vertically extending coded side locking tumblers which are movable independently of each other, there being at least three different code positions for each vertically extending coded side locking tumbler and a plurality of different code combinations for the at least two vertically extending coded side locking tumblers in said longitudinal row in said front region of the key plug, wherein at least one of the two vertically extending coded side locking tumblers is located in front of the first one of the associated cavities disposed adjacent to the front end of the key plug.
